(19) United States
(12) Patent Application Publication
(10) Pub. No.: US 2003/0127025 A1
(43) Pub. Date: Jul. 10, 2003

(54) Novel phosphomagnesium hydraulic binder, and mortar obtained from same

(76) Inventors: Gilles Orange, Soisy Sous Montmorency (FR); Nathalie Riche, Eaubonne (FR)

Correspondence Address: Kevin E McVeigh, Rhodia Inc, Intellectual Property Department, 259 Prospect Plains Road CN 7500, Cranbury, NJ, 08512-7500, US

(21) Appl. No.: 10/297,073

(22) PCT Filed: Jun. 1, 2001
(86) PCT No.: PCT/FR01/01707

(30) Foreign Application Priority Data
Jun. 5, 2000 (FR) 00/07146

(51) Int. Cl. C04B 12/02

(52) U.S. Cl. 106/690; 106/691

(57) ABSTRACT

The invention concerns a novel phosphomagnesium hydraulic binder and a mortar obtained from said novel binder. The phosphomagnesium binder comprises at least a magnesium compound and a mixture of phosphorus compounds, the mixture comprising at least two compounds selected among an aluminum phosphate, a potassium phosphate and an ammonium phosphate. Said binder preserves good mechanical properties after exposure to high temperatures.

The invention relates to a novel phosphomagnesium hydraulic binder and to a mortar obtained from this novel binder.

Phosphomagnesium cements are hydraulic binders, that is to say binders which solidify in the presence of water. They are characterized by a binder based on phosphorus and magnesium compounds.

These cements are particularly advantageous for their speed of setting and their good mechanical properties. This very rapid setting is particularly advantageous in applications such as the repair of structures where rapid reentry into service is desired.

However, phosphomagnesium binders, like the majority of hydraulic binders, exhibit a deterioration in their mechanical properties after exposure to high temperatures. This deterioration does not allow them to be used in applications such as sealing for chimney ducts or fireproof panels.

The aim of the present invention is to provide a novel phosphomagnesium binder which makes it possible to obtain a material which retains its mechanical properties after exposure to high temperatures.

This aim is achieved by the present invention, which relates to a phosphomagnesium binder which comprises at least one magnesium compound and a mixture of phosphorus compounds, the mixture of phosphorus compounds comprising at least two compounds chosen from an aluminum phosphate, a potassium phosphate and an ammonium phosphate.

The invention also relates to a cement matrix which comprises the phosphomagnesium binder of the invention and granular components.

The invention also relates to a process for the preparation of a mortar which comprises the addition of water to the cement matrix and the mixing of the matrix, to which water has been added, in order to obtain a homogeneous and fluid mortar, the amount of water added being such that the W/B ratio is between 0.20 and 0.50, W representing the amount of water and B the amount of magnesium compound and of phosphorus compound, to the mortar thus obtained and to the articles capable of being obtained from the phosphomagnesium mortar.

It has been found, surprisingly, that the use of a phosphomagnesium binder comprising a specific mixture of phosphorus compounds makes it possible to obtain articles which exhibit good mechanical properties at ambient temperature, the mechanical properties of which are retained after exposure to high temperatures.

In the context of the invention, the term “mortar” denotes without distinction mortars or grouts based on phosphomagnesium binder.

As regards the phosphorus compound, any phosphorus-based compound can be used insofar as it comprises phosphorus pentoxide, available directly or in the form of a precursor.

In the context of the invention, mention may be made, without the intention of being limiting, as ammonium phosphate, potassium phosphate and aluminum phosphate, of the ammonium, aluminum and potassium salts of the following phosphorus compounds: phosphorus pentoxide, phosphoric acid or derivatives, such as orthophosphoric acid, pyrophosphoric acid or polyphosphoric acid. The phosphomagnesium hydraulic binder can comprise these phosphorus compounds alone or as a mixture, provided that a mixture as defined above is obtained.

It should be noted that phosphorus-comprising waste from the fertilizer-manufacturing industries or from steelworks (pickling of steel, treatment to reduce corrosion) can be employed as phosphorus compounds.

According to a specific embodiment, the mixture of phosphates is a mixture which comprises an ammonium phosphate and at least one phosphorus compound chosen from a potassium phosphate and an aluminum phosphate.

According to another embodiment, the phosphate mixture comprises an aluminum phosphate and a potassium phosphate.

According to another embodiment, the mixture comprises an aluminum phosphate, an ammonium phosphate and a potassium phosphate.

Preferably, the ammonium salt is an ammonium phosphate or hydrogenphosphates, alone or as a mixture. More preferably still, the ammonium salt is ammonium dihydrogenphosphate, optionally mixed with ammonium tripolyphosphate.

Preferably, the potassium salt is a potassium phosphate.

Preferably, the aluminum salt is an aluminum phosphate or metaphosphate, alone or as a mixture. More preferably still, the aluminum salt is aluminum metaphosphate.

The amount of each of the phosphorus compounds in the mixture varies according to the application envisaged.

A person skilled in the art, according to the use envisaged, can determine by routine tests the optimum amounts of each of the phosphorus compounds in the phosphomagnesium binder.

According to a specific embodiment, the amount of ammonium phosphate(s) is predominant with respect to the total amount of phosphorus compounds used in the composition of the phosphomagnesium binder.

The phosphorus compounds can be provided in the liquid or solid form, preferably in the solid form.

According to a first alternative form, the phosphorus compounds are in the form of particles with a particle size more particularly of at most 300 μm. It should be noted that this value is not critical and that, while it is possible to use constituents with a particle size of greater than 300 μm, milling before incorporation in the composition according to the invention may be desirable. This milling can improve the kinetics of dissolution of the phosphorus compounds.

According to a second alternative form, the phosphorus compounds are used in a form adsorbed on a porous support. Mention may be made, as support, for example, of diatomaceous earths, clay, bentonite, silica or alumina. Adsorption is carried out in a way known per se. Thus, conventionally, the phosphorus compounds, in solution or in suspension, are brought into contact with the support, with stirring, and then the resulting suspension is heated in order to evaporate off the excess liquid. This operation can likewise be carried out by impregnation of the support in a drum or on a rotating disk.

The phosphomagnesium binder also comprises at least one magnesium compound.

Any magnesium-based compound is suitable for the present invention insofar as it reacts with the phosphorus compound in the presence of water.

Mention may be made, by way of example, as suitable for the implementation of the invention, of the following magnesium compounds: magnesium oxide, magnesium hydroxide or magnesium carbonate.

Preferably, a compound based on magnesium oxide is used. “Dead burned” magnesia, usually obtained after calcination of magnesium carbonate at temperatures of greater than 1200° C., is suitable in particular.

Advantageously, the magnesium oxide can be employed in a pure form or can optionally comprise at least one element of the calcium, silicon, aluminum or iron type, these elements generally being in the oxide or hydroxide form. Mention may be made, as example of this type of compound, of dolomite, a mixture comprising in particular magnesium oxide and calcium oxide.

If the magnesium oxide is used in the pure form, the purity of the oxide is at least 80%.

Use is preferably made of magnesium compounds with a specific surface area of less than 10 m²/g. More particularly, the specific surface area is less than 2 m²/g.

Furthermore, the particle size of the magnesium compound is usually between 10 and 500 μm. It would be possible to envisage the use of compounds with a particle size outside the abovementioned range but without this introducing specific advantages. Thus, if the particle size is greater than 500 μm, a milling stage prior to the incorporation in the composition may be necessary. Furthermore, if the particle size of said constituents were smaller than 10 μm, the properties of the composition brought into contact with water might be found to be modified. An increase in the rate of setting of the cement may in particular be observed, unless the content of set retarder is increased, which will be discussed in the continuation of the description. For this reason, the mortar according to the invention might be less advantageous from the viewpoint of use or from the economic viewpoint.

In the phosphomagnesium binder, the proportion of the magnesium compound (expressed as weight of MgO) with respect to that of the phosphorus compounds (expressed as weight of P₂O₅) is more particularly between 1 and 4.

The phosphomagnesium binder of the present invention can be used in the preparation of mortar. A mortar is obtained from a cement matrix which comprises, in addition to the phosphomagnesium binder as defined above, granular components with a mean size which varies according to the application envisaged and optionally additives known in the field of hydraulic binders. The size of the granular components can vary conventionally between 1 and 500 μm.

The mortar is prepared by kneading the cement matrix with water, the W/B ratio being between 0.20 and 0.5, preferably 0.22 and 0.38, W representing the amount of water and B the amount of phosphorus compounds and magnesium compounds constituting the binder.

Mention may be made, as granular components, of sand, SiO₂, TiO₂, Al₂O₃, ZrO₂, Cr₂O₃, talc, mica, kaolin, bentonite, metakaolin, raw dolomite, chromium ore, clinker, vermiculite, perlite, mica, cellulose or slag. They can be synthetic products. This can be crystalline or amorphous compounds obtained, for example, by milling and sieving to the desired size. Condensed silica fume, milled silica, pyrogenic silica or fly ash can also be used. A mixture of inorganic charges which is preferred according to the invention is a mixture which comprises little or nothing in the way of silico-calcareous sands. Use will preferably be made of inorganic components which are stable in the temperature range under consideration.

The fly ash which can be used is generally silico-aluminous ash resulting from combustion in thermal power stations in particular.

The particle size of this ash is usually between 0.5 and 200 μm.

The condensed silica fume, optionally a constituent of the composition according to the invention, generally exhibits a specific surface area of between 20 and 30 m²/g.

The amount of granular components is usually between 0 and 1000 parts by weight per 100 parts by weight of binder.

According to a specific embodiment, the amount of sand, silica or other granular components mentioned in this list is generally between 0 and 900 parts by weight with respect to the same reference as above. Furthermore, the amount of condensed silica fume or fly ash is between 0 and 100 parts by weight.

Finally, the binder can comprise any additive which is conventional in the field of hydraulic binders, such as agents which impart water repellency; plasticizers, in particular alkoxysilanes; or antifoaming agents, in particular antifoaming agents based on polydimethylsiloxanes. Mention may in particular be made, among antifoaming agents of this type, of silicones in the form of a solution or of a solid and preferably in the form of a resin, of an oil or of an emulsion, preferably, in water. Silicones comprising essentially M (RSiO_{0.5}) and D (R₂SiO) units are very particularly suitable. In these formulae, the R radicals, which are identical or different, are chosen more particularly from hydrogen and alkyl radicals comprising 1 to 8 carbon atoms, the methyl radical being preferred. The number of units is preferably between 30 and 120.

The amount of silicone used in the cement according to the invention is less than or equal to 10 parts by weight per 100 parts by weight of binder and preferably less than or equal to 5 parts by weight.

The binder can comprise texture and viscosity agents, for example fibers formed of cellulose, guar, starch, cellulose ether, starch ethers or poly(vinyl alcohol). Conventionally, the cement comprises a set retarder. More particularly, this retarder is chosen from compounds capable of complexing the magnesium.

The latter can in particular be carboxylic acids, such as citric acid, oxalic acid or tartaric acid, boron-comprising acids, esters or salts, phosphorus-comprising acids, esters or salts, such as sodium tripolyphosphate, ferrous sulfate, sodium sulfate and lignosulfonate, zinc chloride, copper acetate, sodium gluconate, sodium cellulose acetate sulfate, the product of the reaction of formaldehyde with aminolignosulfate, dialdehyde starch, N,N-dimethyloldihydroxyethyleneurea, silicofluorides, tall oil and sucrose, these compounds being taken alone or as a mixture.

Use is preferably made, alone or as a mixture, of carboxylic acids and preferably of boron-comprising acids, esters or salts.

Thus, in this latter category of compounds, mention may be made, without the intention of being limiting, of boric acid and its salts, such as salts of alkali metals, for example sodium (borax), or amine or ammonium salts. Boric acid esters are also suitable for the implementation of the invention, such as trialkyloxy borates or triaryloxy borates.

The amount of set retarder is at most 10% [lacuna] weight with respect to the weight of binder. Preferably, this amount is at most 5%.

Generally, such additives do not represent more than 10 parts by weight per 100 parts by weight of binding phase. Preferably, the amount of additives is between 0 and 5 parts by weight. According to a specific form, the additive or additives are employed in the form of a powder with a mean diameter of 10 to 200 μm.

The amount of water to be introduced for the preparation of the mortar according to the invention is such that a homogeneous and malleable plastic paste is obtained. It depends on the subsequent application of the mortar. This is because, if it is desired to produce internal linings for pipework, the paste is generally more cohesive than a mortar intended to form a floor covering, or the preparation of slabs or panels.

The mixing of the phosphomagnesium binder, of the granular components, of the possible additives and of the water can be carried out according to any appropriate method. Thus, it can be carried out by introducing all the components of the mortar, simultaneously or separately. According to this latter possibility, a composition comprising the phosphomagnesium binder, the granular components, if appropriate the set retarder and all or a portion of the possible additives mentioned above, generally in the solid form, is generally prepared. This composition is subsequently mixed with water, the latter comprising, if such is the case, the components not introduced in the preceding stage of preparation of the composition, such as liquid additives.

However, it is preferable to have a cement matrix for which all the components are in the powder form, in order to have to add only water during the kneading.

The essential point of the process is that it is carried out so as to obtain a distribution of all the constituent components which is as homogeneous as possible in the body of the mortar.

The mixing of the constituent components is carried out by any known means and preferably under shear conditions, for example using a kneader.

The mixing operation is advantageously carried out at a temperature in the region of ambient temperature.

The mortar thus obtained can be used as mortars for repairing and sealing, for example in the quick repairing of structures. It can be used to fill in cracks or holes or to cover damaged areas, as well as for the repair of reinforced structures. This is because the mortars or grouts, in addition to resistance to exposure to high temperatures, exhibit good adhesion to “Portland” cements and good mechanical properties of flexural and compressive strength, rendering them particularly suitable for applications of this type.

They can likewise be employed as floor coverings or pipework linings, even in contact with aggressive media.

They can also be used for the production of panels, in particular of panels for internal or external cladding, which can be exposed to high temperatures. For this, the mortar is cast in an appropriate mold to give slabs or panels. The mortar can also be sprayed. The molded or sprayed products are subsequently dried, advantageously at a temperature in the region of ambient temperature.

Finally, it is possible to prepare, from these mortars, refractory compounds which have to withstand high temperatures, such as sealing mortars for chimney ducts or fireproof panels.

The mortar of the present invention described above can comprise fibers. Composite materials are thus obtained. Mention may be made, by way of example, of fibers made of polypropylene, of polyester or of polyaramide, such as, for example, Kevlar®, carbon fibers, polyamide, poly(vinyl alcohol), amorphous cast iron tapes or glass fibers.

Any glass fiber commonly employed in cements is suitable. Use may therefore be made of alkali-resistant fibers, such as the special glass fibers obtained in particular by treatment with zirconium, as ell as soda-lime glass fibers. Standard fibers are also suitable for producing composite materials according to the invention. Thus, conventional glasses, such as borosilicate glasses, which are usually destroyed in an alkaline medium.

The fibers have lengths varying from 1 mm to several tens of millimeters.

The amount of fibers in the composite material according to the invention is between 0.1 and 10% with respect to the weight of binder, preferably between 0.1 and 4%.

The composite materials according to the invention are obtained by mixing the cement as defined above with the fibers.

The following examples illustrate the invention without, however, limiting the scope thereof.

### EXAMPLES

Preparation of the Samples

The samples tested are prepared using a kneader of the Perrier type by mixing the constituents described below for 4 minutes under dry conditions and by then adding the water. Kneading is subsequently carried out for two minutes at slow speed and then for two minutes at high speed. The mixture is cast in prism-shaped molds (10 mm×10 mm×10 cm).

These test specimens are removed from the molds 1 hour after the setting time and are stabilized in a climate-controlled atmosphere at 20° C. and a constant level of humidity for 1 to 2 days. The test specimens are then placed in an oven at the desired temperature for ½ a day. After cooling, the flexural tensile strengths are measured.

The tests are carried out in three-point bending (NFP 18407) with a distance of 70 mm and a rate of 0.5 mm per minute on six test specimens using a hydraulic testing machine (200 kN).

### Example 1 (Comparative)

The following phosphomagnesium binder is prepared (% by weight):

50% by weight of MgO (magnesia),

50% by weight of ammonium phosphate (NH₄)₂HPO₄, sold by Rhodia.

The following are added to this binder:

5% by weight of silica T92, sold by Rhodia, with respect to the weight of binder,

2.5% by weight of boric acid, with respect to the weight of binder.

This composition is kneaded with water under the conditions described above, the water/binder ratio by weight being 0.22.

The following results are obtained according to the heat treatment.

| Temperature (° C.) | Flexural strength (MPa) |
|---|---|
| 20 | 7.6 |
| 150 | 2.1 |
| 250 | 2.2 |
| 350 | 1.5 |
| 500 | 3.4 |
| 850 | 1.7 |

These results show that, when the binder comprises only ammonium phosphate, the flexural strength after exposure to high temperature falls rapidly.

### Example 2

The following phosphomagnesium binder is prepared (% by weight):

50% of MgO,

40% of ammonium phosphate (NH₄)₂HPO₄ binder, sold by Rhodia,

10% of aluminum phosphate (analytical purity, sold by Aldrich).

The following are added to this binder:

5% by weight of silica T92, sold by Rhodia, with respect to the weight of binder,

2.5% by weight of boric acid, with respect to the weight of binder.

The Water/Binder ratio is equal to 0.26.

The following results are obtained according to the heat treatment.

| Temperature (° C.) | Flexural strength (MPa) |
|---|---|
| 20 | 7.5 |
| 200 | 3.5 |
| 250 | 3.1 |
| 350 | 3.7 |
| 500 | 3.5 |
| 850 | 4.2 |

These results show that the flexural strength after exposure to high temperature (e.g.: 850° C.) is improved by the use of ammonium phosphate and of an aluminum phosphate.

### Example 3

The following phosphomagnesium binder is prepared (% by weight):

50% of MgO,

17.5% of ammonium phosphate (NH₄)₂HPO₄ binder, sold by Rhodia,

5% of aluminum phosphate (analytical purity, sold by Aldrich),

17.5% of potassium phosphate (analytical purity, sold by Aldrich),

10% of aluminum metaphosphate (analytical purity, sold by Aldrich).

The following are added to this binder:

5% by weight of silica T92, sold by Rhodia, with respect to the weight of binder,

2.5% by weight of boric acid, with respect to the weight of binder.

The Water/Binder ratio is equal to 0.16.

The following results are obtained according to the heat treatment.

| Temperature (° C.) | Flexural strength (HPa) |
|---|---|
| 20 | 8.1 |
| 200 | 5.1 |
| 250 | 4.3 |
| 350 | 4.1 |
| 500 | 4.2 |
| 850 | 9.9 |

These results show that the flexural strength after exposure to high temperatures is improved by the use of ammonium phosphate, of aluminum phosphate and of potassium phosphate.

1. A phosphomagnesium binder which comprises at least one magnesium compound and a mixture of phosphorus compounds, the mixture comprising at least two compounds chosen from an aluminum phosphate, a potassium phosphate and an ammonium phosphate.

2. The binder as claimed in claim 1, in which the mixture comprises an ammonium phosphate and at least one [lacuna] aluminum phosphate and a potassium phosphate.

3. The binder as claimed in claim 1, in which the mixture comprises an aluminum phosphate and a potassium phosphate.

4. The binder as claimed in claim 1, in which the mixture comprises an ammonium phosphate, an aluminum phosphate and a potassium phosphate.

5. A cement matrix, comprising the phosphomagnesium binder as defined in any one of claims 1 to 4, granular components and optionally one or more additives.

6. The matrix as claimed in claim 5, in which the granular components have a size of between 0.1 and 500 μm.

7. A process for the production of a phosphomagnesium mortar, which comprises the addition of water to the cement matrix defined in either of claims 5 and 6 and the mixing of the matrix, to which water has been added, in order to obtain a homogeneous and fluid mortar, the amount of water added being such that the W/B ratio is between 0.20 and 0.50, W representing the amount of water and B the amount of magnesium compound and of phosphorus compound.

8. An article comprising the binder as defined in any one of claims 1 to 4.
